(19) United States
(12) Patent Application Publication
(10) Pub. No.: US 2002/0129051 A1
(43) Pub. Date: Sep. 12, 2002

(54) Previewing portions of the hypertext World Wide Web documents linked to hyperlinks in received World Wide Web documents

(75) Inventors: Sanaa F. Abdelhadi, Austin, TX (US); Hypatia Rojas, Round Rock, TX (US)

Correspondence Address: Volel Emile, International Business Machines Corporation, Intellectual Property Law Department, 11400 Burnet Road, Internal Zip 4054, Austin, TX, 78758, US

(73) Assignee: International Business Machines Corporation, Armonk, NY (US)

(21) Appl. No.: 09/801,617

(22) Filed: Mar. 8, 2001

(51) Int. Cl. G06F 17/21

(52) U.S. Cl. 707/501.1; 707/526

(57) ABSTRACT

System through which a Web user may distinguish those hyperlinks in each received Web document which are of interest to him. At a receiving display station, a user is enabled to select to view only a portion of a hypertext document linked to a hyperlink in any received hypertext document. The user is also permitted to select the size of the portion of the linked document to be viewed. Then, there is provided, preferably in the browser, an implementation for accessing and storing at the one receiving display station, the selected portion of the linked hypertext document; and for then displaying said stored portion of a linked document to the user. The user may then review this preview portion of the document and decide whether he wishes to see the whole linked Web document.

### CROSS-REFERENCE TO RELATED PATENT APPLICATION

The following copending patent application, assigned to the assignee of the present invention, covers subject matter related to the subject matter of the present patent application and is entitled, NETWORK HYPERTEXT DOCUMENT TRANSMISSION TO RECEIVING DISPLAY STATIONS HAVING APPARATUS FOR PRELIMINARY ACCESS AND STORAGE OF LINKED DOCUMENTS PRIOR TO SELECTION OF ANY LINKING HOTSPOT ON A RECEIVED DOCUMENT, Mullaly et al., Ser. No. 09/306,197, filed May 6, 1999.

### TECHNICAL FIELD

The present invention relates to computer managed communication networks, such as the World Wide Web (Web) and, particularly, to ease of use of interactive computer controlled display interfaces to receive hypertext documents with hyperlinks that interactively link users from such documents to other documents and programs.

### BACKGROUND OF RELATED ART

The past decade has been marked by a technological revolution driven by the convergence of the data processing industry with the consumer electronics industry. The effect has, in turn, driven technologies which have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources which were at first text and then evolved into media, i.e. “hypermedia”. This even further exploded the use of the Internet or Web. It was now possible for the Web browser or wanderer to literally spend hours going through document after document in often less than productive excursions through the Web. These excursions often strained the users' time and resources. In order for the Internet to mature from its great expectations to solid commercial fruition, it will be necessary for the Internet to greatly reduce its drain on time and related resources. A significant source of this drain is in the Web page (the basic document page of the Web) itself.

In the case of Web pages, we do not have the situation of a relatively small group of professional designers working out the human factors; rather, in the era of the Web, anyone and everyone can design a Web page. Pages are frequently designed by developers without usability skills. As a result, Web pages are frequently set up and designed in an eclectic manner. Often Web pages are set up through loose business, professional, social and educational configurations with general trade or public input of Web pages. The names or identifiers selected for the hyperlinks by Web page hosts or authors are often very similar to each other. As a result, the user going through one or a series of Web searches or browses will find it virtually impossible to recognize the more important hyperlinks to significant Web documents and pages. Thus, the user may spend considerable time going around in circles. The providers of Web searches have addressed this problem to some extent by tracking the frequency with which Web documents are accessed and often list the Web documents and pages in search results in the order in which such documents and pages are universally accessed or “hit” in past Web searches. However, once the user accesses a particular Web document or page, there is no guidance as to which hyperlinks on the received Web page are linked to Web documents of greater or lesser significance. Thus, in order to determine whether the user has an interest in a document linked to a particular hyperlink, it is necessary for the Web browser supporting the display station to access the whole linked Web document. At this point, the user is essentially at the mercy of the linked document designer, i.e. the browser begins a download and display of the whole hypertext document, which could be quite lengthy. While some Web browsers do provide the user with the ability to interrupt the download of a requested Web document before the document is completely downloaded and to return to a previous stage, the review of the incoming document by the user to determine his interest still must be done “on the fly” while the document download continues.

### SUMMARY OF THE PRESENT INVENTION

The present invention provides a simple and effective system through which the Web user may distinguish those hyperlinks in each received Web document which are of interest to him. The invention provides means associated with one of said receiving display stations for enabling a user to select to view only a portion of a hypertext document linked to a hyperlink in any received hypertext document. The user is also permitted to select the size of the portion of the linked document to be viewed. Then, there are provided means, preferably in the browser, for accessing and storing at the one receiving display station the selected portion of the linked hypertext document; and for then displaying said stored portion of a linked document to the user. The user may then review this preview portion of the document and decide whether he wishes to see the whole linked Web document.

The invention, thus, involves a method enabling a user at a receiving display station in the Web to select to view only a portion of a Web page; and responsive to said user selection, accessing said portion of said Web page from the Web and displaying said accessed portion of said Web page. Actually, this method is applicable to communication networks in general to provide for viewing a portion of a document transmittable over the network comprising requesting a portion of a transmittable document, transmitting the requested document portion and displaying the transmitted portion on a display terminal in the network.

While the present invention is directed to satisfying present needs in network and, particularly, Web systems, the principles of the invention are equally applicable to stored data files associated with independent computer systems. The invention could be applicable to a method in a computer controlled display system for viewing a portion of a document comprising requesting a portion of a stored document, obtaining the requested document portion and displaying the obtained portion.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter which is capable of functioning as a user interactive Web station for receiving Web documents;

FIG. 2 is a generalized diagrammatic view of a Web portion showing how the Web may be accessed from the Web stations for the requesting Web pages and for accessing portions of Web documents linked to hyperlinks in received Web documents;

FIG. 3 is a diagrammatic view of an illustrative received Web page in its normal state including all of its hyperlinks which will provide the illustrative example for the process of the present invention;

FIG. 4 is the diagrammatic view of FIG. 3 after the user has selected to preview the Web document linked to a selected hyperlink;

FIG. 5 is a diagrammatic view of the document portion preview selected in FIG. 4;

FIG. 6 is a diagrammatic view of the whole document previewed in FIG. 5;

FIG. 7 is a general flowchart of a program set up to implement the present invention for previewing of portions of documents linked to the hyperlinks in a received Web page; and

FIG. 8 is a flowchart of an illustrative run of the program set up in FIG. 7.

### DETAILED DESCRIPTION OF THE PREFERRED EMBODIMENT

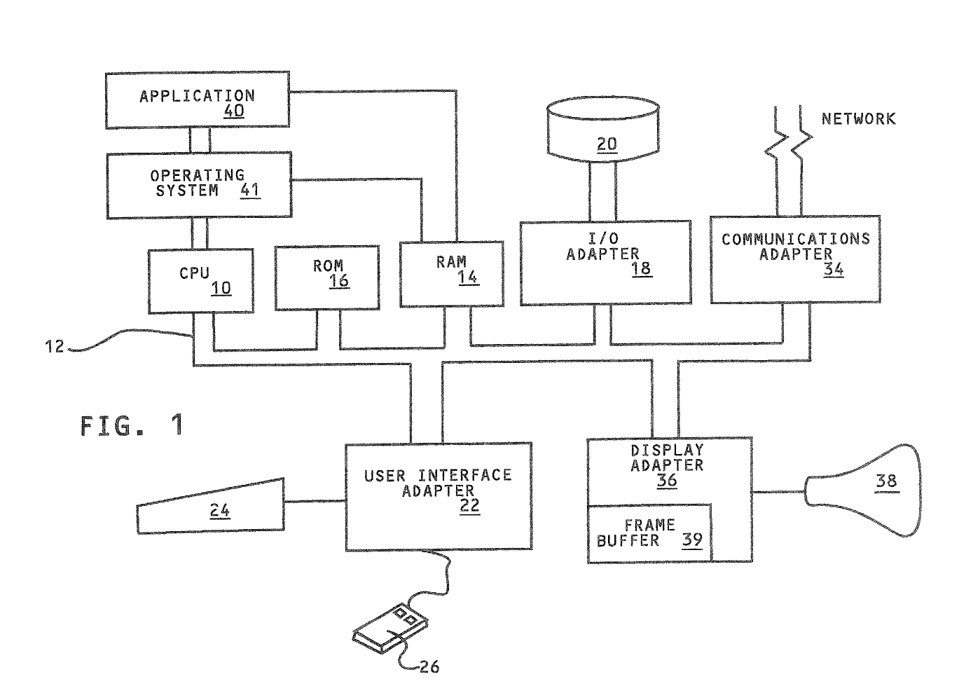

Referring to FIG. 1, a typical data processing terminal is shown which may function as the computer controlled network terminal or Web display station used for receiving Web pages, for requesting previews of portions of Web documents linked in hyperlinks in received Web documents and for Web browsing. A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows98™ or Windows NT™, as well as the UNIX and AIX operating systems. Application programs 40, controlled by the system, are moved into and out of the main memory Random Access Memory (RAM) 14. These programs include the programs of the present invention for the previewing of portions of hypertext Web documents linked to hyperlinks in received Web documents to be subsequently described in combination with any conventional Web browser, such as the Netscape Navigator 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with the Web or Internet. The latter two terms are meant to be generally interchangeable and are so used throughout this application and the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods which may be related to the present invention. Since a major aspect of the present invention is directed to Web pages transmitted over global networks such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999.

Any data communication system which interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. In addition, aspects of this invention will involve Web browsers. A general and comprehensive description of browsers may be found in the above-mentioned Mastering the Internet text at pp. 291-313. More detailed browser descriptions may be found in the above-mentioned Internet: Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

The invention will also use search engines for searching. As described in the Internet, Milleniun Edition text, pages 395 and 522-535, search engines use keywords and phrases to query the Web for the desired subject matter. Usually the keywords used in designing Web queries may be combined with some of the basic Boolean operators: AND, OR and NOT.

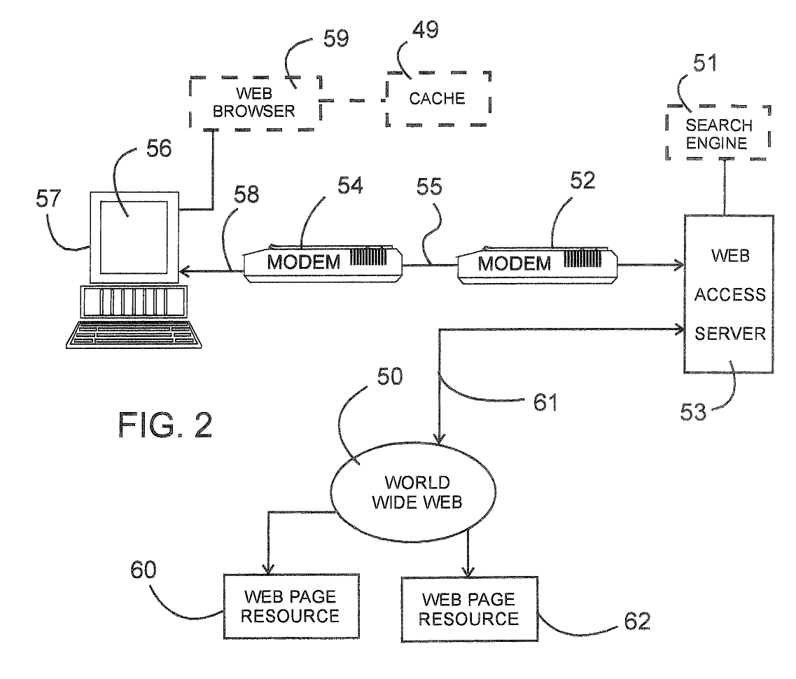

A generalized diagram of a portion of the Internet, which the computer controlled display terminal 57 used for Web page receiving during searching or browsing, is connected as shown in FIG. 2. Computer display terminal 57 may be implemented by the computer system set up in FIG. 1 and connection 58 (FIG. 2) is the network connection shown in FIG. 1. For purposes of the present embodiment, computer 57 serves as a Web display station and has received displayed Web page 56, which is one of a sequence of Web pages containing embedded hyperlinks to other Web pages.

Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 which are linked 61 to the Web 50. The servers 53 may be maintained by a service provider to the client's display terminal 57. The host's server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 computer to control the communication with the Web access server 53 to thereby download and display the accessed Web pages 56 on terminal 57. The Web access server 53 uses one of the previously described search engines to access via the Web 50 and the desired sequence of Web pages from appropriate Web resources such as databases 60 and 62.

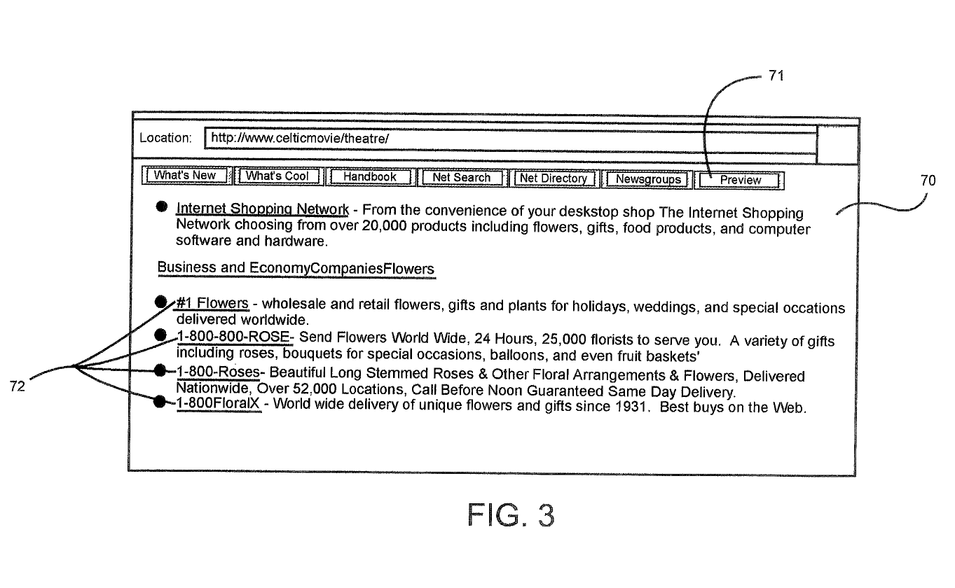

With this set up, the present invention, which will be subsequently be described in greater detail with respect to FIGS. 3 through 8, may be carried out using search engine 51, as well as Web browser 59 and browser cache 49 in FIG. 2. When the user initiates a search through browser 59, the search engine 51 conducts the search and makes the results available to the browser which then accesses the Web documents or pages produced by the search. The user then goes through the search results and accesses the Web pages as desired from the list of titles in the search results provided to the user through the browser and has the browser access the Web documents.

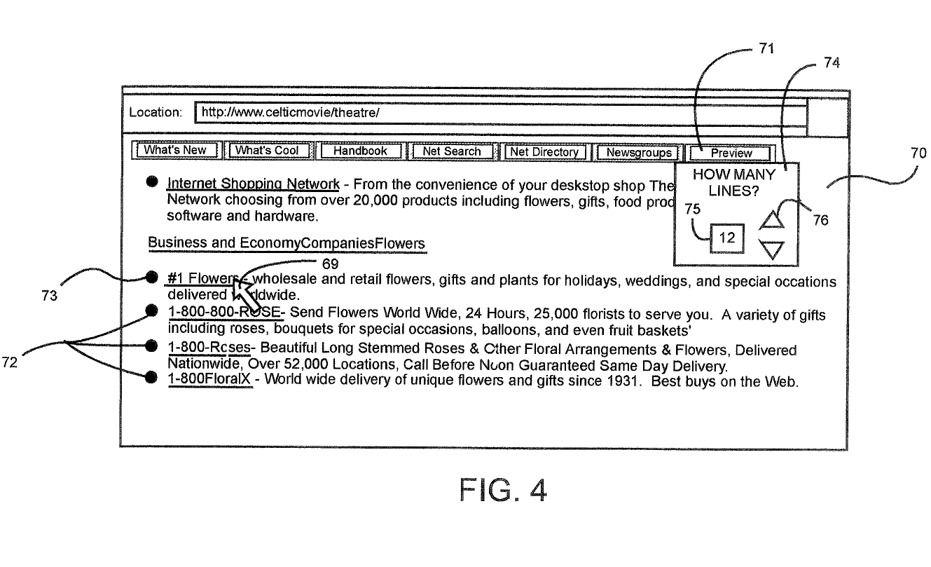

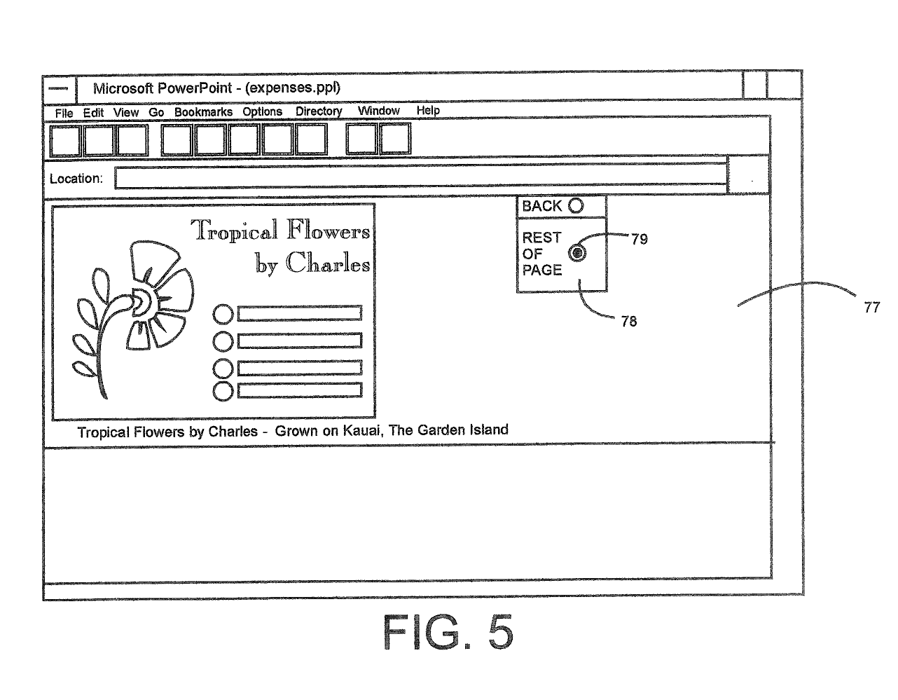

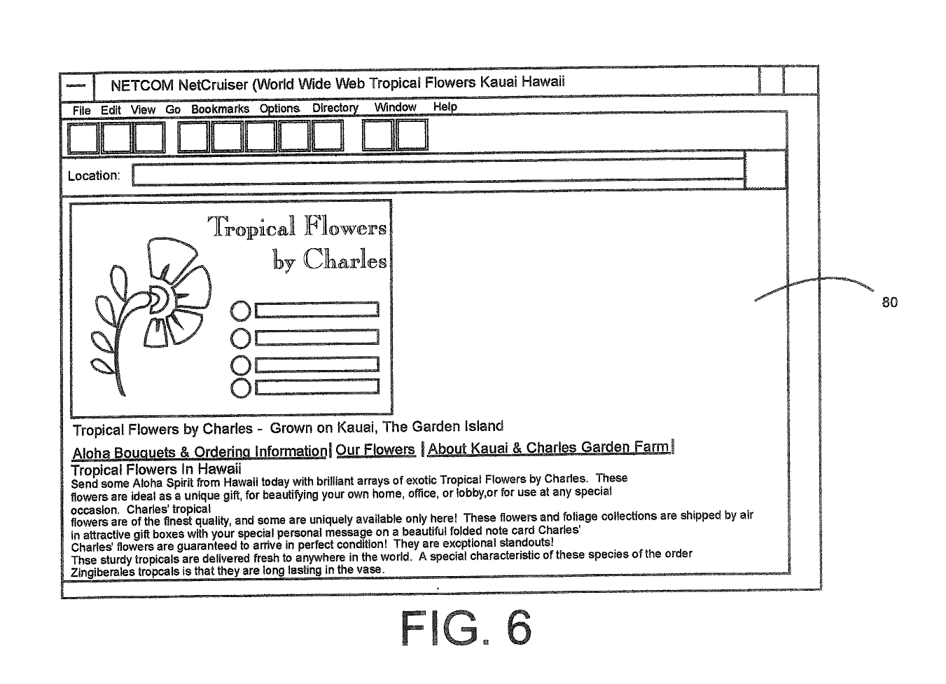

FIGS. 3 through 6 are diagrams of illustrative Web pages used in the practice of the present invention. A typical Web page 70, which may be received via the Web, is shown in FIG. 3. It contains hyperlinks, such as terms 72. On the present received page 70, the hyperlinks have been underlined to designate them as hyperlinks. After the page is received, the user may wish to access the hypertext Web documents respectively linked to any of the hyperlinks 72. In order to save user time and system bandwidth, the present invention gives the user the opportunity to preview only a portion of each linked document before requesting the whole linked document. He does so by clicking on “Preview” button 71. This activates the display screen dialog shown in FIG. 4. The user must cursor or point to the hyperlink selected for document preview, e.g. cursor 69 pointing to hyperlink 73, “#1 Flowers”. A dialog box 74 also opens and the user is prompted to enter the number of lines of the linked hypertext document which he wishes to preview. In the present case, the shown value 75 is “12”, which is the default value that the user may change through up-down input 76. The entries shown in FIG. 4 result in the preview 77 of the hyperlinked document shown in FIG. 5. After the user views the portion 77, he has the dialog box 78 option of going back to the initial Web page 70, FIG. 3, or obtaining the rest of the previewed linked page or document. The dialog box 78, FIG. 5, indicates that the user has selected the latter 79, whereby the remainder of the linked document 80 is obtained and displayed as shown in FIG. 6.

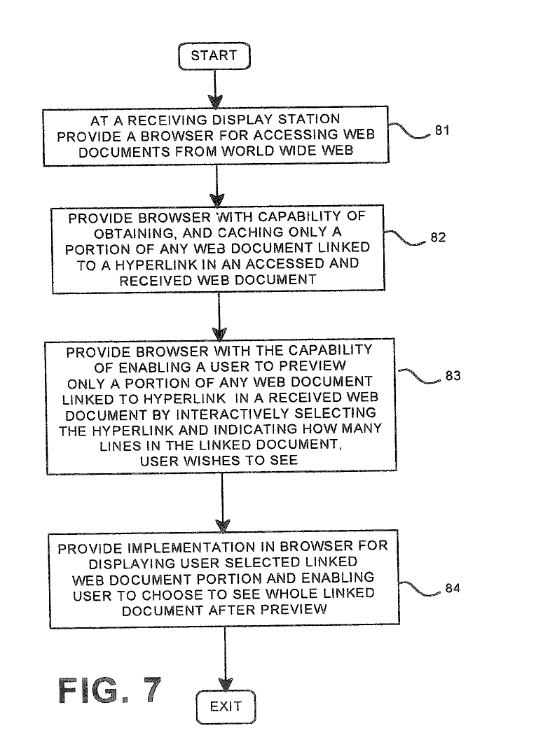

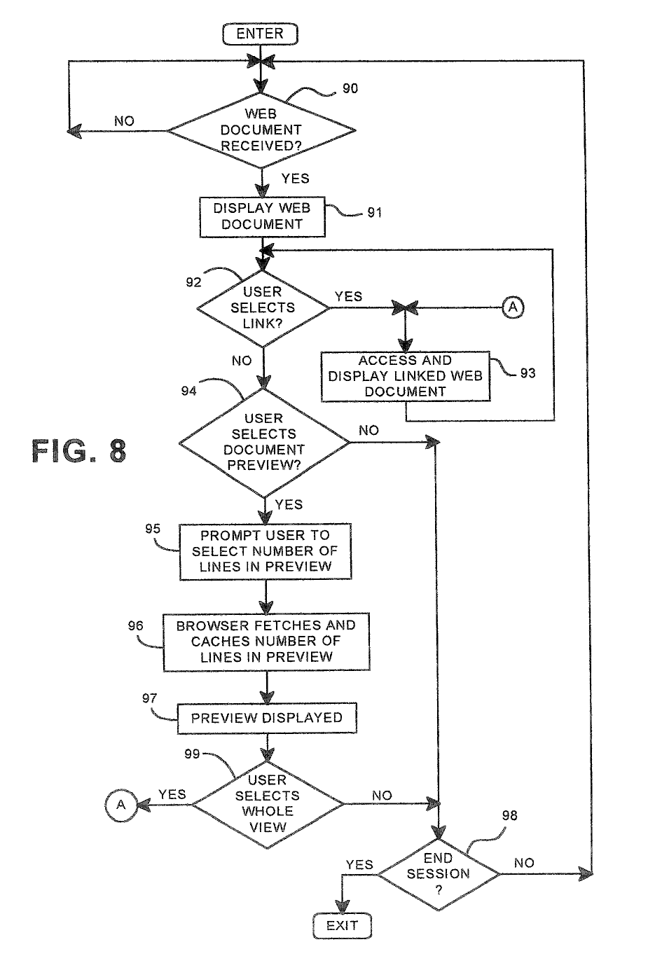

Now with reference to FIGS. 7 and 8, we will describe a process implemented by the present invention in conjunction with the flowcharts of these figures. FIG. 7 is a flowchart showing the development of a process according to the present invention for previewing any hypertext Web document linked to hyperlinks in a received Web document. A Web browser is provided at a receiving display station on the Web for accessing Web pages in the conventional manner and loading them at the display station, step 81. The browser is provided with the capability of obtaining and caching only a portion of any Web document linked to a hyperlink in an accessed and received Web document, step 82. The browser is also provided with the capability of enabling the user to preview only a portion of any Web document linked to a hyperlink in a received Web document by interactively selecting the hyperlink and indicating how many lines in the linked document that the user wishes to see, step 83. Implementation is provided in the browser for displaying user selected linked Web document portion and enabling the user to choose to see the whole linked document after the user preview, step 84. The browser should be coacting with a Web access server (server 53, FIG. 2) that has the capability of accessing and transmitting portions of documents. In the practice of the invention, the browser may be set up to read the hyperlinks in a received Web page and to preaccess and cache each Web document or page linked to each hyperlink in the received page as described in the above cross-referenced copending Application: Mullaly et al., Ser. No. 09/306,197. In this manner, if the user chose to preview a portion of an already cached document in accordance with the present invention, the preview of the portion would be expedited by having the portion already cached. On the other hand, if the user did not choose to preview a document, then the setup would still have the advantages of having the linked documents preaccessed in accordance with said copending application.

The running of the process set up in FIG. 7 and described in connection with FIGS. 3 through 6 will now be described with respect to the flowchart of FIG. 8. A determination is made at the receiving display station as to whether the browser has accessed a Web page, step 90. If No, the process is returned to step 90, and the receipt of a Web page is awaited. If Yes, the received Web document is displayed, step 91. Then, a determination is made, step 92, as to whether the user has selected a hyperlink in the conventional manner. If Yes, the Web hypertext document is accessed and displayed, step 93, and the process is then returned to step 92 where a determination is made as to whether the user has made another selection as described above. If a decision from step 92 is No, then a further determination is made, step 94, as to whether the user has selected to have a Web document linked to a hyperlink on the received Web page previewed. If Yes, then, step 95, the user is prompted to select the number of lines of previewed document that he wishes to see. The Web browser then fetches and caches in cache 49 (FIG. 2) the number of preview lines requested, step 96, and the preview portion of the linked Web document is displayed, step 97.

At this point, provision may optionally be made for determining whether the selected portion of the document would include an incomplete image. If such an incomplete image is included, then this incomplete image may be excluded by transmitting the selected portion in a text only mode. Since image data is digitally intensive, this exclusion of a useless image should enhance the saving of time and transmission bandwidth. For a method of transmitting Web documents in a text only mode, reference is made to copending application: REDUCING DOWNLOADING TIME FOR WEB DOCUMENTS AT WORLD WIDE WEB RECEIVING DISPLAY STATIONS BY PRESELECTING SPECIFIED WEB DOCUMENTS TO BE DOWNLOADED IN A TEXT-ONLY MODE. G. F. McBrearty et al., Ser. No. _________.

Then, step 99, a determination is made as to whether the viewer has selected to view the whole preview document. If Yes, the process is returned to step 93 via branch “A”; the whole Web document linked to the selected hyperlink is displayed and the above process is continued from that step. If the decision from either step 94 is No, i.e. the user does not access a preview, or step 99 is No, i.e. the viewer does access the whole linked document, a determination may be conveniently made as to whether the session is over, step 98. If Yes, the session is exited. If No, the process is returned to initial step 90 where the receipt of the next Web document is awaited.

One of the preferred implementations of the present invention is in application program 40, i.e. a browser program made up of programming steps or instructions resident in RAM 14, FIG. 1, of a Web receiving station during various Web operations. Until required by the computer system, the program instructions may be stored in another readable medium, e.g. in disk drive 20, or in a removable memory such as an optical disk for use in a CD ROM computer input, or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims. For example, the invention does have applications beyond the Web or Internet examples given. The transmission of only a selected portion of any document transmitted over any network should result in substantial savings in user time, as well as network bandwidth.

What is claimed is:

1. In a World Wide Web (Web) communication network with user access via a plurality of data processor controlled interactive receiving display stations for displaying received hypertext documents of at least one display page containing text, images and a plurality of embedded hyperlinks, each hyperlink being user selectable to access and display a respective linked hypertext document, a system for enabling a user to selectively preview each hypertext document linked to the hyperlinks in each received hypertext document comprising:
means associated with one of said receiving display stations for enabling a user to select to view only a portion of a hypertext document linked to a hyperlink in any received hypertext document;
means for accessing and storing at said one receiving display station said portion of said linked hypertext document; and
means responsive to said means for enabling said user selection for displaying said stored portion of a linked document.

2. The Web system of claim 1 further including means for enabling a user to select to view the full linked hypertext document after the user has viewed a portion of said full linked document.

3. The Web system of claim 2 wherein said means for enabling the user to select to view only a portion of a linked document enable the user to select the size of the portion of the linked document to be viewed.

4. The Web system of claim 2 wherein said one receiving display station further includes a user interactive Web browser, said Web browser including:
said means for enabling a user to select to view only a portion of any hypertext document linked to a hyperlink in a received hypertext document;
said means for accessing and storing said portion of said linked hypertext document; and
said means responsive to said means for enabling said user selection for displaying said stored portion of a linked document.

5. In a Web communication network with user access via a plurality of data processor controlled interactive receiving display stations for displaying received hypertext documents of at least one display page containing text, images and a plurality of embedded hyperlinks, each hyperlink being user selectable to access and display a respective linked hypertext document, a method for enabling a user to selectively preview each hypertext document linked to the hyperlinks in each received hypertext document comprising:
enabling a user to select to view only a portion of any hypertext document linked to a hyperlink in a hypertext document received at one of said receiving display stations;
accessing and storing at said one receiving display station said portion of said linked hypertext document; and
displaying said stored portion of a linked document responsive to said user selection.

6. The method of claim 5 further including the step of enabling a user to select to view the full linked hypertext document after the user has viewed a portion of said full linked document.

7. The method of claim 6 wherein said step of enabling the user to select to view only a portion of a linked document further enables the user to select the size of the portion of the linked document to be viewed.

8. The method of claim 6 further including a Web browser method operatively associated with at least said one receiving display station, said Web browser method including said steps of:
enabling a user to select to view only a portion of a hypertext document linked to a hyperlink in a received hypertext document;
accessing and storing said portion of said linked hypertext document; and
displaying said stored portion of a linked document responsive to said user selection.

9. A computer program having code recorded on a computer readable medium for enabling a user to selectively preview each hypertext document linked to the hyperlinks in each received hypertext document in a Web communication network with user access via a plurality of data processor controlled interactive receiving display stations for displaying received hypertext documents of at least one display page containing text, images and a plurality of embedded hyperlinks, each hyperlink being user selectable to access and display a respective linked hypertext document, said program comprising:
means associated with one of said receiving display stations for enabling a user to select to view only a portion of a hypertext document linked to a hyperlink in any received hypertext document;
means for accessing and storing at said one receiving display station said portion of said linked hypertext document; and
means responsive to said means for enabling said user selection for displaying said stored portion of a linked document.

10. The computer program of claim 9 further including means for enabling a user to select to view the full linked hypertext document after the user has viewed a portion of said full linked document.

11. The computer program of claim 10 wherein said means for enabling the user to select to view only a portion of a linked document enables the user to select the size of the portion of the linked document to be viewed.

12. The computer program of claim 10 wherein said one receiving display station further includes a user interactive Web browser program, said Web browser including:
said means for enabling a user to select to view only a portion of any hypertext document linked to a hyperlink in a received hypertext document;
said means for accessing and storing said portion of said linked hypertext document; and
said means responsive to said means for enabling said user selection for displaying said stored portion of a linked document.

13. In a Web communication network with user access via a plurality of receiving display stations for displaying accessed Web pages a method comprising:
enabling a user at one of said receiving display stations to select to view only a portion of a Web page; and responsive to said user selection:
accessing said portion of said Web page from the Web, and displaying said accessed portion of said Web page.

14. The method of claim 13 wherein:
said selected portion includes an incomplete image; and
said portion is accessed and displayed in a text only mode.

15. A computer program having code recorded on a computer readable medium for enabling a user at a receiving display station on the Web to preview a Web page comprising:
means enabling a user at said receiving display station to select to view only a portion of a Web page; and
means responsive to said user selection for accessing said portion of said Web page from the Web, and for displaying said accessed portion of said Web page.

16. The computer program of claim 15 wherein:
said selected portion includes an incomplete image; and
said means responsive to said selection access and display said portion in a text only mode.

17. In a comunications network, a method for viewing a portion of a document transmittable over the network comprising:
requesting a portion of a transmittable document;
transmitting said requested document portion; and
displaying said transmitted portion on a display terminal in said network.

18. A computer program having code recorded on a computer readable medium for enabling a user at a display terminal in said network to preview a Web page comprising:
means for requesting a portion of a transmittable document;
means for transmitting said requested document portion; and
means for displaying said transmitted portion on a display terminal in said network.

19. In a computer controlled display system, a method for viewing a portion of a document comprising:
requesting a portion of a stored document;
obtaining said requested document portion; and
displaying said obtained portion.

20. A computer program having code recorded on a computer readable medium for enabling a user in a computer controlled display system to preview a document comprising:
means for requesting a portion of a document;
means for obtaining said requested document portion; and
means for displaying said obtained portion on said computer controlled display system.
